(19) United States
(12) Patent Application Publication
(10) Pub. No.: US 2026/0154800 A1
(43) Pub. Date: Jun. 4, 2026

(54) Systems and Methods for Generating Data for Training Inspection Algorithms

(71) Applicant: Rapiscan Holdings, Inc., Hawthorne, CA (US)

(72) Inventors: Ankita Shukla, Brighton, MA (US); David Feingold, Rancho Palos Verdes, CA (US); Randall Barnby, Winthrop, MA (US); Denis Dujmic, Arlington, MA (US)

(21) Appl. No.: 19/178,384

(22) Filed: Apr. 14, 2025

Related U.S. Application Data
(60) Provisional application No. 63/727,440, filed on Dec. 3, 2024.

(51) Int. Cl. G06T 7/00; G06T 5/60

(52) U.S. Cl. CPC G06T 7/0002; G06T 5/60; G06T 2207/10116; G06T 2207/20081; G06T 2207/20084

(57) ABSTRACT

Systems and methods support a plurality of different machine learning frameworks to be applied to image data that is acquired from one or more inspection systems. The received image data and at least one machine learning framework is used to generate artificial image data that is physically consistent representation of image data obtained by one or more inspection systems. The quality of the generated artificial image data is determined in order to remove hallucinated image data. Curative features are applied to the generated artificial image data to create generated and curated image data. One or more algorithms are developed using the generated and curated image data for implementation by the one or more inspection systems.

### CROSS-REFERENCE

The present application relies on, for priority, U.S. Patent Provisional Application No. 63/727,440, titled “Systems and Methods for Generating Data for Training Inspection Algorithms” and filed on Dec. 3, 2024, which is herein incorporated by reference in their entirety.

The present specification relates to United States Patent Publication No. 20210405243, which relies on U.S. Pat. Nos. 9,111,331, 9,632,206, 10,422,919, 10,509,142, 11,099,294, and 10,830,920 for priority. The present specification also relates to U.S. Pat. Nos. 9,772,426 and 10,302,807 and United States Patent Publication No. 20240046635.

### FIELD

The present invention relates to performing security inspection operations, and more particularly to systems and methods for generating scan data for developing security inspection algorithms using machine learning, deep learning, neural networks, and/or convolutional neural networks.

### BACKGROUND

The globalization of trade has opened international boundaries for the exchange of goods but has also paved the way for the illegal transportation of contraband such as explosives, narcotics, counterfeit goods, undisclosed currency, chemical, and nuclear weapons. To determine the legitimacy and applicable import laws for a given shipment of cargo, cargo containers are typically associated with a corresponding manifest document, which is an electronic or physical document having descriptive information about the cargo containers such as bills, the shipment consigner, consignee, cargo description, amount, value, origin, and/or destination. The manifest enables individuals at import or export checkpoints to determine whether transporting cargo is permitted and, if so, what duties, costs, or fees may be associated therewith.

Cargo must be inspected at transportation centers, such as ports or airports. The cargo is often inspected physically to determine if the contents correspond with the manifest. As a result, customs agencies worldwide face the monumental task of inspecting traffic through seaports, airports and border crossings efficiently and effectively. The challenge is not only to facilitate legitimate trade and travel but also to intercept illegal activities and contraband without causing undue delay. The need to balance uninterrupted transportation of people and goods with an effective interception of illegal activities and contraband, constrains the fraction of containers at seaports and border crossings that can be manually inspected with non-intrusive techniques, such as those using X-rays, to around a few percent.

Security systems at the transportation centers are limited in their ability to accurately detect contraband or other dangerous objects, which are often well hidden in the cargo containers. In particular, the detection of the contraband is difficult since corresponding inspection images are superimposed, confounding permitted cargo with the contraband, thereby resulting in a difficulty in determining the threat levels associated with the corresponding images. The inspection performed using radiation-based systems, which enable the rapid imaging of cargo contents without the delays typically caused by using solely physical inspection, frequently need to be supplemented using physical inspection conducted by security personnel. An operator must analyze the images to detect the level of threat associated with the corresponding objects in the images, making it prone to human errors and adding excessive time into the process. Automated systems, to the extent they can be accurate in determining whether the cargo contents match a manifest and/or contain contraband, are therefore preferred over manual inspection operations.

Air cargo, including passenger bags, are scanned with X-rays for security reasons, without exception. Typically, a few X-ray images resulting from the scan are individually analyzed to detect customs violation(s). The application of automated inspection algorithms has revolutionized the analysis of X-ray images and customs inspection. However, despite the success and improvements to the speed and accuracy of inspection systems using the automated inspection algorithms, the algorithms are limited in their ability to discern illegal and/or contraband materials in the cargo. Thus, there is still a significant reliance on the need for physical inspection due to the prevalence of false positives by the automated inspection systems, in turn leading to an overall delay in inspection.

The most promising algorithms for customs inspection are those based on a Machine Learning (ML) approach where model inspection parameters are tuned using real scan data. However, developing ML algorithms for customs inspection is hampered by a significant obstacle, most notably the scarcity of curated and labeled inspection data. The reason for data scarcity is twofold: first, the low scan rate and low prevalence of some illicit cargo or container types mean that not enough data is available to train ML algorithms and secondly, privacy and security concerns for sharing the scan data further keep existing datasets away from algorithm developers.

Inspection data for training ML algorithms is currently generated in a test facility or lab environment. However, ML algorithms require large datasets and generating such datasets with different object types and variations is expensive and time-consuming. This is particularly impractical for creating scan data of large containers. Another approach is to model the scan objects and Non-Intrusive Inspection (NII) equipment with computer code and create simulated datasets. However, it may be obvious to those skilled in the art that modeling different scan objects and variations is only slightly easier than recreating the scan data in a lab. For example, realistic simulation of passage of X-rays or neutrons through scanned objects can be slow, computer intensive, and expensive. Creating CAD models and variations of scanned objects and conveyances is especially difficult for containerized cargo.

In addition, it should be noted that scanning equipment may introduce different types of artifacts or noise, which may appear over a period of time as the equipment ages. Such artifacts may not be present in historic datasets. As a result, developers of algorithms are typically unaware of the presence of the artifacts or how to handle such cases.

There is therefore a need to provide systems and methods for creating ML training datasets for automated customs and security inspection. There is also a need to provide realistic, unlimited training data and to overcome the requirement of creating such data from scratch. There is still further a need to improve the use of algorithms, that can support customs entities to analyze vast amounts of imaging data from X-ray imaging devices and NII devices and to quickly identify patterns and anomalies that human inspectors might overlook. Therefore, there is also a need to identify quality issues with generated datasets, which are expected to occur due to scanning equipment aging or malfunction. There is a need for an improved system and method for performing a security inspection operation that is efficient and can overcome the abovementioned drawbacks. Additionally, there is a need to address the above-mentioned concerns by creating systems and methods that generate artificial customs inspection data with datasets related to types of manifolds and conveyance.

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also correspond to implementations of the claimed technology.

### SUMMARY

The following embodiments and aspects thereof are described and illustrated in conjunction with systems, tools and methods, which are meant to be exemplary and illustrative, and not limiting in scope. The present application discloses numerous embodiments.

The present specification disclose a computer readable non-transitory medium comprising a plurality of executable programmatic instructions that, when executed in a computer system, enables a plurality of different machine learning frameworks to be applied to image data, wherein the image data is acquired from one or more inspection systems and wherein the plurality of executable programmatic instructions, when executed: receives the image data from the one or more inspection systems; using the received image data and at least one machine learning framework, generates artificial image data that is physically consistent representation of the received image data; detects a characteristic of the generated artificial image data; receives an instruction to apply one or more curative features to the generated artificial image data based on the detected characteristic to create generated and curated image data; develops one or more processes using the generated and curated image data for implementation by at least one of an operator workstation and the one or more inspection systems; and causes at least one of the operator workstation and the one or more inspection system to implement the one or more developed processes.

Optionally, the received image data is at least partially representative of cargo.

Optionally, the received image data is acquired by the operator workstation in data communication with at least one of the one or more inspection systems.

Optionally, the computer readable non-transitory medium further comprises programmatic instructions that, when executed, train the at least one machine learning framework based on the received image data.

Optionally, the at least one machine learning framework comprises at least one generative adversarial network (GAN). Optionally, the GAN comprises at least one generator neural network and at least one discriminator neural network.

Optionally, the received image data is representative of at least one of a two-dimensional X-ray image, a three-dimensional X-ray image, a tomographic X-ray image, a multi-energy X-ray image, a backscatter X-ray image, and a transmission X-ray image.

Optionally, the curative features comprise at least one of labels and annotations to the generated image data.

Optionally, the detection of the characteristic comprises determining whether the generated image data comprises hallucinations indicative of one or more unrealistic features and further comprises a plurality of executable programmatic instructions that, when executed, separates the hallucinations from the generated image data.

The present specification also discloses a method of enabling a plurality of different machine learning frameworks to be applied to image data, wherein the image data is acquired from one or more inspection systems and, said method comprising: receiving image data from the one or more inspection systems; using received image data and at least one machine learning framework, generating artificial image data that is substantially similar to the received image data; detecting a quality characteristic of the generated artificial image data; receiving an instruction to apply one or more curative features to the generated artificial image data based on the detected quality characteristic to create generated and curated image data; and developing one or more processes using the generated and curated image data for implementation by at least one of an operator workstation and the one or more inspection systems; and causing at least one of the operator workstation and the one or more inspection system to implement the one or more developed processes.

Optionally, the received image data is at least partially representative of cargo.

Optionally, the received image data is acquired by the operator workstation in data communication with at least one of the one or more inspection systems.

Optionally, the method further comprises training the at least one machine learning framework based on the received image data.

Optionally, the at least one machine learning framework comprises at least one generative adversarial network (GAN). Optionally, the GAN comprises at least one generator neural network and at least one discriminator neural network.

Optionally, the received image data is representative of at least one of a two-dimensional X-ray image, a three-dimensional X-ray image, a tomographic X-ray image, a multi-energy X-ray image, a backscatter X-ray image, and a transmission X-ray image.

Optionally, the applying the curative features comprises at least one of applying labels and annotations to the generated image data.

Optionally, the method further comprises determining whether the generated image data comprises hallucinations indicative of one or more unrealistic features and separating the hallucinations from the generated image data.

The present specification also discloses a system comprising: one or more inspection systems that produce image data; at least one computing system in data communication with the one or more inspection systems and configured to implement one or more machine learning frameworks that receive the image data from the one or more inspection systems and generate artificial image data that is substantially similar to the received image data, wherein the at least one computing system comprises a user interface configured to: enable detecting quality characteristics of the generated artificial image data; and receive an instruction to apply curative features to the generated artificial image data to create generated and curated image data for developing one or more algorithms for implementation by the one or more inspection systems.

Optionally, at least one of the one or more machine learning frameworks comprises a GAN.

Optionally, the received image data is representative of at least one of a two-dimensional X-ray image, a three-dimensional X-ray image, a tomographic X-ray image, a multi-energy X-ray image, a backscatter X-ray image, and a transmission X-ray image.

In embodiments, the present specification is directed towards a system for generating curated artificial image data for training inspection algorithms, the system comprising: one or more inspection systems configured to generate real image data representative of scanned cargo or conveyance; a computing system in data communication with the one or more inspection systems, the computing system comprising: a memory configured to store programmatic instructions and image data; a processor configured to execute the programmatic instructions to: receive real image data from the one or more inspection systems; apply a generative adversarial network (GAN) to the real image data to generate artificial image data that is a physically consistent representation of the real image data; detect hallucinated features within the artificial image data using a hallucination detection process comprising a neural network and a support vector machine; separate the artificial image data into a first group of validated artificial image data and a second group comprising hallucinated artificial image data; receive, via a graphical user interface, user input to apply curative features comprising labels or annotations to the validated artificial image data to create curated artificial image data; and use the curated artificial image data to develop a machine learning model for detecting cargo type or contraband; and a graphical user interface (GUI) operable by a user to: review artificial image data; identify hallucinated or artifact-containing images; and apply annotations to image regions corresponding to known objects, containers, or cargo patterns.

Optionally, the one or more inspection systems include an X-ray scanner configured to acquire three dimensional (3D) volumetric image data of scanned cargo, and wherein the artificial image data comprises synthetic 3D voxel-based representations.

Optionally, the computing system is further configured to apply the generative adversarial network to multi-energy scan data comprising low-energy and high-energy X-ray channels and to generate corresponding artificial dual-energy images.

Optionally, the hallucination detection algorithm process is configured to detect hallucinated features by extracting a feature vector using a convolutional neural network, and classifying the feature vector using the support vector machine trained to distinguish real from unreal image features.

Optionally, the graphical user interface is further configured to allow the user to apply a custom labeling of image regions to designate cargo categories, threat types, or container subtypes.

Optionally, the computing system is further configured to inject one or more scanner artifacts into the artificial image data, and wherein the scanner artifacts comprise at least one of underexposure, scan interruption, scan skew, detector misalignment, and system noise profiles.

Optionally, the system further comprises a database, wherein the computer system is configured to store the curated artificial image data in the database with metadata linking each image to at least one of a class label, an origin identifier, and a hallucination verification score.

Optionally, the computing system is further configured to perform receiver operating characteristic (ROC) analysis to evaluate a performance of the trained machine learning model using both real and artificial test datasets.

Optionally, the artificial image data includes simulated threat objects embedded into cargo scenes which otherwise do not have threats using object insertion algorithms that preserve physical coherence and X-ray attenuation gradients.

Optionally, the machine learning model trained on the curated artificial image data is configured to detect at least one of concealed persons, undeclared electronics, weapons, narcotics, and vehicle parts.

The aforementioned and other embodiments of the present specification shall be described in greater depth in the drawings and detailed description provided below.

### BRIEF DESCRIPTION OF THE DRAWINGS

The accompanying drawings illustrate various embodiments of systems, methods, and embodiments of various other aspects of the disclosure. Any person with ordinary skills in the art will appreciate that the illustrated element boundaries (e.g. boxes, groups of boxes, or other shapes) in the figures represent one example of the boundaries. It may be that in some examples one element may be designed as multiple elements or that multiple elements may be designed as one element. In some examples, an element shown as an internal component of one element may be implemented as an external component in another and vice versa. Furthermore, elements may not be drawn to scale. Non-limiting and non-exhaustive descriptions are described with reference to the following drawings. The components in the figures are not necessarily to scale, emphasis instead being placed upon illustrating principles.

FIG. 1 are graphs illustrating the consequences of using insufficient data to train a machine learning (ML) algorithm;

FIG. 2 illustrates examples of images generated using cargo containers with different loads, in accordance with embodiments of the present specification;

FIG. 3 is an exemplary X-ray image of a cargo container showing both objects and human stowaways, and a corresponding exemplary image generated with the objects masked to highlight stowaways, in accordance with embodiments of the present specification;

FIG. 4 are pictures illustrating examples of some of the artifacts resulting from equipment malfunctions, which are artificially generated or simulated for ML algorithm training, in accordance with embodiments of the present specification;

FIG. 5A is an exemplary raw X-ray image of a cargo container;

FIG. 5B is an exemplary raw X-ray image, as shown in FIG. 5A, further illustrating annotation and labelling, in accordance with embodiments of the present specification;

FIG. 6 is a block diagram showing an exemplary GAN architecture, according to an embodiment of the present specification;

FIG. 7 is a graph showing the quality of an artificially generated image by virtue of the resemblance or similarity of the generated image to the real image, using FID scores, in an embodiment of the present specification;

FIG. 8 is a flow diagram showing an exemplary process for creating generative, curated datasets to generate training data for security inspection algorithms, in accordance with the various embodiments of the present specification;

FIG. 9A illustrates an example of hallucination which shows a generated image of container or truck parts that are hanging in the air;

FIG. 9B illustrates an example of hallucination which shows a generated image that includes a blurred or washed-out region;

FIG. 10A is a diagram showing a correlation between different hallucination detection methods evaluated before finalizing the chosen approach;

FIG. 10B is a graph showing the performance of multiple combined hallucination rejection methods evaluated before finalizing the chosen approach;

FIG. 10C is a graph illustrating a ROC curve for the finalized hallucination detector on exemplary pineapple container images;

FIG. 10D illustrates an exemplary set of features for data curation, which may be used within embodiments of the present specification;

FIG. 11A illustrates a ROC curve comparison for empty cargo containers;

FIG. 11B illustrates a ROC curve comparison for banana containers;

FIG. 11C illustrates a ROC curve comparison for beer containers;

FIG. 11D illustrates a ROC curve comparison for carton containers;

FIG. 11E illustrates a ROC curve comparison for coffee containers;

FIG. 11F illustrates a ROC curve comparison for ethylene copolymer containers;

FIG. 11G illustrates a ROC curve comparison for glass containers;

FIG. 11H illustrates a ROC curve comparison for papaya containers;

FIG. 11I illustrates a ROC curve comparison for pineapple containers;

FIG. 11J illustrates a ROC curve comparison for watermelon containers;

FIG. 12 is an overview of a network within which data generation and curation is performed to train one or more ML algorithms;

FIG. 13 is a block diagram showing an exemplary system architecture, according to embodiments of the present specification;

FIG. 14A illustrates an example GUI, in accordance with some embodiments of the present specification; and

FIG. 14B illustrates another example GUI 1400b, in accordance with some embodiments of the present specification.

### DETAILED DESCRIPTION

The present specification is directed to systems and methods for creating generative, curated image data for developing automated inspection algorithms. Some embodiments of the present specification employ Generative Adversarial Networks (GANs) to generate artificial inspection data to improve the training and development of customs inspection algorithms.

The present specification is directed towards multiple embodiments. The following disclosure is provided in order to enable a person having ordinary skill in the art to practice the invention. Language used in this specification should not be interpreted as a general disavowal of any one specific embodiment or used to limit the claims beyond the meaning of the terms used therein. The general principles defined herein may be applied to other embodiments and applications without departing from the spirit and scope of the invention. Also, the terminology and phraseology used is for the purpose of describing exemplary embodiments and should not be considered limiting. Thus, the present invention is to be accorded the widest scope encompassing numerous alternatives, modifications and equivalents consistent with the principles and features disclosed. For the purpose of clarity, details relating to technical material that is known in the technical fields related to the invention have not been described in detail so as not to unnecessarily obscure the present invention.

Some embodiments of this disclosure, illustrating all its features, will now be discussed in detail. The words “comprising,” “having,” “containing,” and “including,” and other forms thereof, are intended to be equivalent in meaning and be open-ended in that an item or items following any one of these words is not meant to be an exhaustive listing of such item or items, or meant to be limited to only the listed item or items. It should be noted herein that any feature or component described in association with a specific embodiment may be used and implemented with any other embodiment unless clearly indicated otherwise.

It must also be noted that as used herein and in the appended claims, the singular forms “a,” “an,” and “the” include plural references unless the context dictates otherwise. Although any systems and methods similar or equivalent to those described herein can be used in the practice or testing of embodiments of the present disclosure, the preferred, systems and methods are now described.

‘Dataset’ herein refers to collection of related sets of information obtained from one or more inspection systems including and not limited to cargo and people screening systems, which are deployed for security purposes. A dataset contains multiple points of data, where each data point is representative of one or more objects in an image. In the present specification, dataset also refers to non-intrusive inspection data obtained from scanners, which can be used to adjudicate inspection scans. The dataset may include X-ray images, shipping documentation, visual photographs of objects being scanned (conveyance, license plate, people, surveillance video, radiation detection information, among others). In embodiments, the one or more inspection systems include an X-ray scanner configured to acquire three dimensional (3D) volumetric image data of scanned cargo, and wherein the artificial image data comprises synthetic 3D voxel-based representations.

The systems and methods described throughout this specification are advantageous for several reasons. First, methods of the present specification are used to create an unlimited dataset for any type of cargo or conveyance and is not restricted by different types of scanning platforms used for security screening at different transportation hubs. Second, the generative data are created using algorithm output and does not necessarily require raw security inspection data input. Therefore, the present specification mitigates privacy and security concerns of most customs agencies which relate to sharing security inspection data with developers. An additional advantage is that the pool of developers who can access the (algorithm output) data is expanded and therefore a larger set of skilled developers can contribute to the development efforts.

Embodiments of the present disclosure will be described more fully hereinafter with reference to the accompanying drawings in which like numerals represent like elements throughout the several figures, and in which example embodiments are shown. Embodiments of the claims may, however, be embodied in many different forms and should not be construed as limited to the embodiments set forth herein. The examples set forth herein are non-limiting examples and are merely examples among other possible examples.

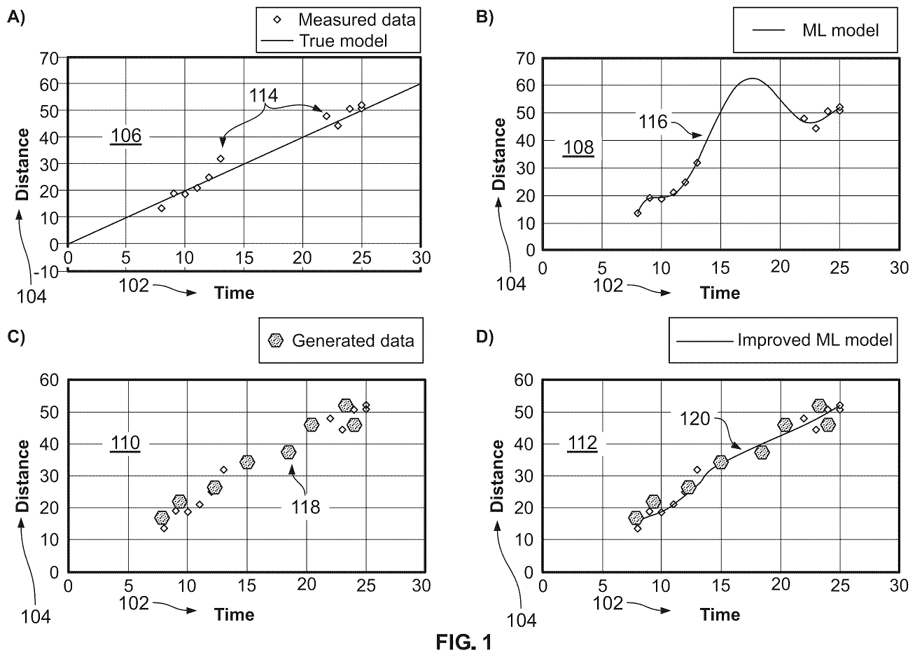

FIG. 1 shows graphs 106, 108, 110, and 112 that illustrate the consequences and effects of using insufficient data to train a machine learning (ML) algorithm. Each graph 106, 108, 110 and 112 shows a measurement of time along an X-axis 102 and a measurement of distance along a Y-axis 104. Each graph 106, 108, 110 and 112 shows the plot of measured data 114 as a function of time versus distance, where the measured data is not sufficient to accurately train an ML algorithm. The first graph 106 illustrates measured data 114 assuming the dataset consists of two measured parameters with a gap between data points. Measured data 114 is referred to as dataset having a low statistic, which is an indication of being based on a low number of data points. It is known to those of ordinary skill that low statistics may prevent ML training convergence, or lead to at least one anomaly in the trained ML model. Low statistics can impact modeling of both dominant and rare classes of data. Dominant data refers to a statistically dominant dataset, where abundant data pertaining to a type of scanned object is available. For example, a cargo type or a container type of a scanned cargo or container may include an abundance of statistical data, since these objects are scanned with a greater frequency. Conversely, rare data classes refer to objects with low prevalence, for example people positioned inside cargo containers, X-ray images with rare quality problems such as drivers stopping inside the scanner during a scan, among other infrequent instances in scanning.

The second graph 108 illustrates a conventional ML model 116 plotted as a function of time versus distance where the model has been trained using the insufficient dataset of measured data 114. Model 116 exhibits anomalous behavior in the region where data points are missing in the true model shown in graph 106. Training of data using ML model 116 results in the adjustment of the model parameters to achieve a desired result based on a predefined success score (which is also known as the loss function). In these cases, the training process tends to accommodate high prevalence cases corresponding to the dominant dataset and neglects the low prevalence cases corresponding to the rare data classes, since the latter has low impact on the success score.

The third graph 110 illustrates data 118 that is generated using the methods of the present specification, using, as an initial input, measured data 114. Generated data 118 interpolates into the region with existing and missing data points of measured data 114. The fourth graph 112 illustrates an ML model 120 trained using generated data 118, which improves the fidelity of the model. Therefore, an added advantage of the present specification is that the generated data created by methods of the present specification create high-statistics datasets which are suited to training of machine learning (ML) algorithms. Generated data that is derived from the methods of the present specification can reduce dataset bias by augmenting data corresponding to rare data classes and/or balancing data classes or scenarios to achieve more accurate models. Dataset quantity and diversity is improved, which is critical to develop robust ML models.

Another benefit of the methods of the present specification is that a dataset can be generated to represent different types of items within a cargo, which may include different types of commodities within a single container. For example, a container may include different types of fruits, such as apples and oranges, placed in a mixed manner. In another example, a container may include illicit items such as explosives or any other contraband mixed with different types of fruits, in a single container. While most containers (generally amounting to numbers above 90%) are used to carry a single type of commodity, there are rare cases where the containers can be used to transport a mixture of legitimate commodities or sometimes to hide illegitimate items (contraband) between legitimate commodities. Methods of the present specification can generate datasets that create cargo patterns for commodities that may be uniform, mixed, or mixed with illicit objects.

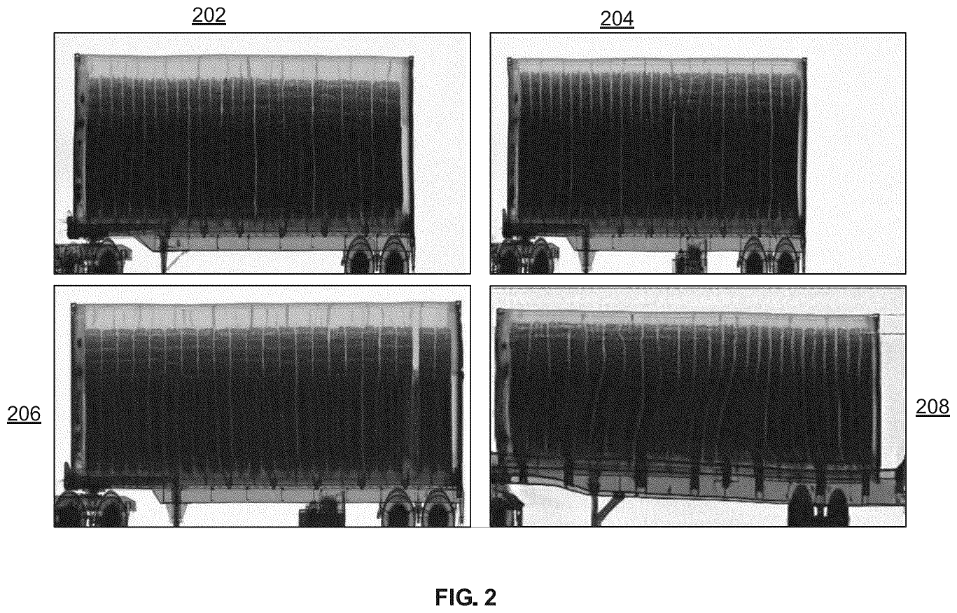

FIG. 2 illustrates examples of generated images 202, 204, 206 and 208 of loaded cargo containers, in accordance with the present specification. Therefore, images 202, 204, 206, and 208 are examples of the same commodity (bananas, in this example) that have been generated with variations in packaging. A close-up view of the images reveals the banana shapes (either frontal or sideways views). In addition, images of other cargo types are similarly generated and used for training models for classifying cargo. The generated images are created or targeted to be physically consistent representations of the real images to which they correspond.

It should be noted that in many cases, it is not obvious to an inspection officer as to how the X-ray pattern for a specific cargo type should look. Conventionally, some algorithms have been developed that assist operators by showing historic images of the same cargo type. However, the disadvantage here is that historic images must be permanently stored in a database and sent over the network to the officer terminal for display. This requires a large data storage and consumes network bandwidth. Therefore, in embodiments of the present specification, the image generator may be used to create images of the particular cargo type, in real-time, in the officer terminal or at the officer workstation.

In embodiments, the datasets are generated in the form of x-ray images. The images that are generated using a GAN and described herein are exemplary. In embodiments, the datasets may comprise shipping documentation text that can also be generated to train algorithms for classifying cargo based on the cargo description. In embodiments, the text generation is demonstrated using the bag-of-words model and a large language model.

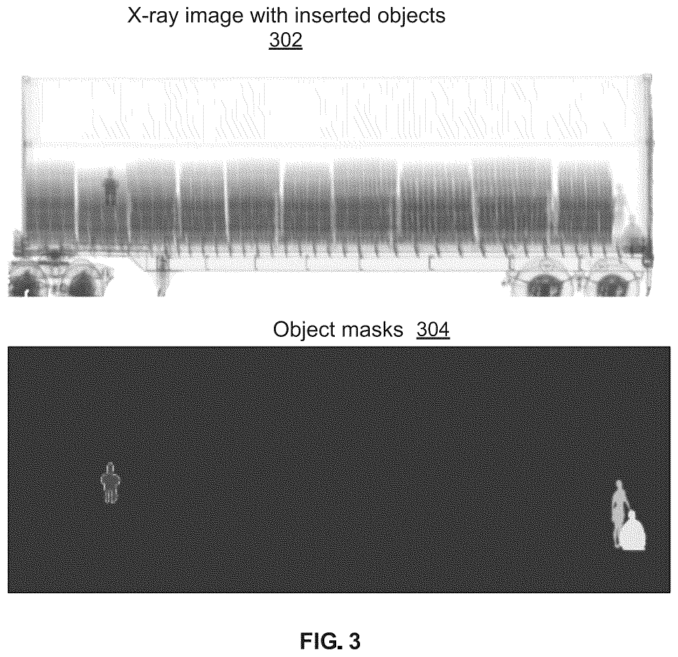

The above advantage of creating generated datasets with a pattern for commodities also applies to cases where people (“stowaways”) are hidden among commodities. Therefore, methods of the present specification can be used to create or generate datasets that create cargo pattern(s) for commodities that may be mixed with unauthorized people. X-ray images of containers with stowaways are extremely rare and creation of X-ray images in a lab setting with people is considered unethical. In embodiments of the present specification, images of cargo that have been generated containing simulated images of stowaways are provided with labels to distinguish the type of cargo and container and with annotations to highlight objects and people. FIG. 3 is an exemplary X-ray image 302 of a cargo container showing both objects and human stowaways, and a corresponding exemplary image 304 generated with the objects masked to highlight stowaways, in accordance with embodiments of the present specification.

Yet another advantage of the present specification is that artificial images generated by the present methods include examples of datasets that may not be available in the real datasets sourced from actual inspection data. For example, such datasets may include those containing artifacts due to equipment malfunction. Equipment malfunctions may result from several reasons, such as and not limited to, equipment age. Malfunctions may result in the modification of the scanned data, which create artifacts that can confuse algorithms.

FIG. 4 illustrates examples of artifacts that may result from equipment malfunctions, which are artificially generated or simulated for ML algorithm training, in accordance with the present specification. Images 402, 404, 406, 408, 410, 412 and 414 are examples of artifacts in images resulting from normalization or calibration problems. Of these, images 402, 404, 406, 408, 410 are examples of images detected with wrong contrast. Image 402 is too dark while image 404 is too bright. In image 406, the front portion of the image is too dark, and the rear portion of the image is too bright. Image 408 shows a disturbance since the air value (yields of unobstructed pixels (‘air’ yields)) varies in the vertical direction along the imaging array. Image 410 has artifacts that appear as noise in a column format which may result due to an abnormal air value. Images 412 and 414 show images with skewed colors.

Images 416, 418, 420, 422, 424, 426, 428, and 430 are examples of problems related to scan execution. Image 416 is obtained when a scan starts too early, and the cab/driver is irradiated. Image 418 is obtained when the scan starts too late, and the image of the container is incomplete. Image 420 is obtained when the scan stops too early, resulting in the image of the container being cut-off. Image 422 is obtained when the scan speed is too low. Image 424 is obtained when the scan speed is too high. Image 426 is obtained when the scan continues for too long. Image 428 contains images of two separate containers obtained in a single scan. Image 430 is an image without an object. Images 432, 434 and 436 are a result of problems with a detector array of the inspection system. Image 432 is obtained with bad detectors. Image 434 is a result of a failed readout. Image 436 includes a large amount of noise. Images 438 and 440 are a result of radiation source related problems. In image 438, ‘missing linac pulses’ create dark vertical lines in X-ray images and 0.1% of such pulses can bias cargo type classification 10% of the times. Image 440 is obtained when there are penetration problems. Image 442 includes artifacts due to interference from other systems. Image 444 is a result of problems due to data conversion. Examples of artifacts such as those illustrated in FIG. 4 may not be present in actual scan data if the equipment is new, thereby limiting the possibility of identifying subsequent presence of artifacts in the images, since the conventional automated inspection systems are not trained to do so. Methods of the present specification can generate data with these artifacts inserted into the images to enable algorithm developers to handle such cases for when the malfunctions do arise.

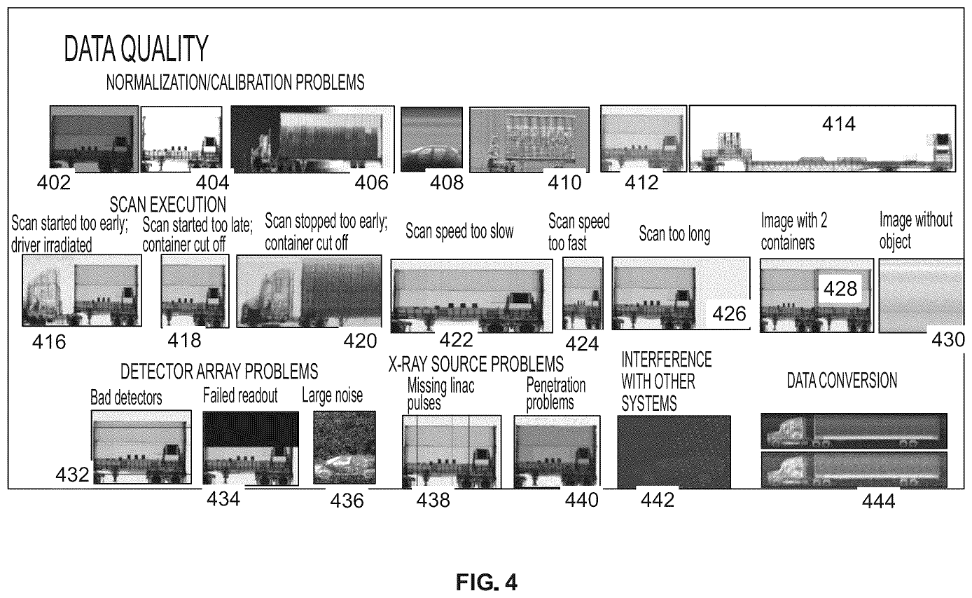

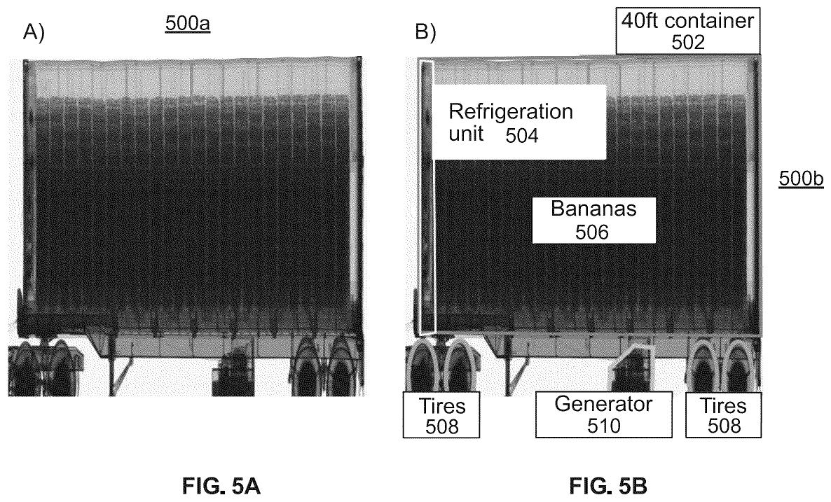

FIG. 5A is an exemplary raw X-ray image of a cargo container. While image 500a is complete and without artifacts, it does not discern the different components within the image. Embodiments of the present specification provide automatic annotation and labelling functions to image datasets. Automated annotation and labelling are provided in both raw data as well as artificially generated images. FIG. 5B is an exemplary raw X-ray image 500b, shown as 500a in FIG. 5A, where FIG. 5B further illustrates annotation and labelling, in accordance with embodiments of the present specification. Image 500b shows highlights and labels for components including size and outline of the cargo container 502, a refrigeration unit 504 within the container, contents 506 of the container (labeled ‘Bananas’ in this case), tires 508, and generator 510. As a result of the illustrated data curation features, methods of the present specification significantly speed up ML algorithm development. The additional data curation information enables the developers to focus on specific cargo types, conveyance types or locations that are prone to smuggling or other illicit activities.

In embodiments, data generated using the methods of the present specification can be used to augment actual scan data (also referred to herein as raw data) if available. Therefore, developers can use both actual scan data and artificially generated data for ML algorithm training. In addition to training of ML algorithms, data generated by the present specification can be used to train security personnel with information about identifying different types of irregular cargo patterns, cases of combinations of different types of objects or commodities that may be mixed with illicit objects or contraband and people hidden within cargo.

### Generative Adversarial Networks (GANs)

Using at least one GAN is one of the possible methods to achieve artificial image generation that is realistic, in accordance with the methods and systems of the present specification. In addition to GANs, embodiments of the present specification may use methods involving and not limited to variational autoencoders, transformer-based models, diffusion models, Boltzmann machines, and any other similar technique as may be known to those of skill in the art to generate realistic images. Other machine learning frameworks may be employed for the purposes of training inspection algorithms by generating artificial image data, as discussed herein. Therefore, embodiments of the present specification may incorporate models that generate text, such as, but not limited to, for example shipping documentation, photographic images such as those of license plates, among other types of data in addition to X-ray scan images.

GANs are a class of machine learning frameworks that consist of two neural networks—a Generator network and a Discriminator network, which are trained simultaneously through adversarial processes. The Generator network creates synthetic data samples, while the Discriminator network evaluates the synthetic data samples from the Generator network against actual (real) data, while providing feedback to improve the Generator network's output. The adversarial training approach helps GANs generate highly realistic data, making them valuable in applications such as image synthesis, video generation, and data augmentation.

One of ordinary skill in the art would appreciate that the features described in the present application can operate on any computing platform including, but not limited to: a laptop or tablet computer; personal computer; personal data assistant; cell phone; server; embedded processor; DSP chip or specialized imaging device capable of executing programmatic instructions or code.

It should further be appreciated that the platform provides the functions described in the present application by executing a plurality of programmatic instructions, which are stored in one or more non-volatile memories, using one or more processors and presents and/or receives data through transceivers in data communication with one or more wired or wireless networks.

It should further be appreciated that each computing platform has wireless and wired receivers and transmitters capable of sending and transmitting data, at least one processor capable of processing programmatic instructions, memory capable of storing programmatic instructions, and software comprised of a plurality of programmatic instructions for performing the processes described herein. Additionally, the programmatic code can be compiled (either pre-compiled or compiled “just-in-time”) into a single application executing on a single computer, or distributed among several different computers operating locally or remotely to each other.

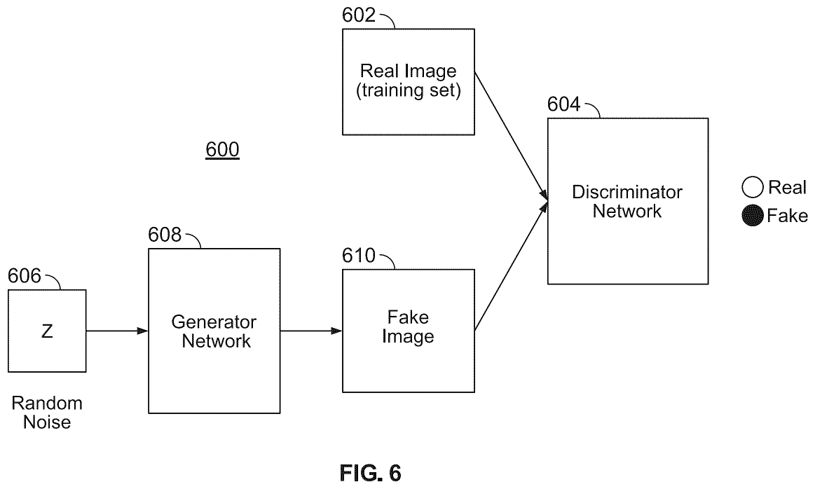

FIG. 6 illustrates a block diagram showing an exemplary GAN architecture 600, according to an embodiment. GAN 600 may include a first database 602 of images for training, which are fed to a first neural network or discriminator network 604. Images in first database 602 include real images from security inspection systems such as X-ray imaging devices used to screen vehicles and cargo containers for illicit objects, contraband, or stowaways. A random noise generator 606 is configured to provide noise to a second neural network or generator network 608, which in turn is configured to generate artificial images that are stored in a second database 610 (of artificial images). Random noise generator 606 is a numerical (algorithmic) noise generator that uses a method such as linear congruential generation to create a sequence of numbers that appear uncorrelated, random, or without a pattern. Generator network 608 is, in turn, configured to generate artificial or synthetic data from the random noise generator 606. The aim of generator network 608 is to generate data that is indistinguishable from real data such as that stored in first database 602. Second database 610 also feeds images to discriminator network 604. The first database 602 sources images from actual security inspection devices or systems, and therefore includes actual scanned images from the real world, or real images whereas, in contrast, second database 610 sources artificially generated or simulated images that may or may not match the real images obtained by security inspection systems. Discriminator network 604 is configured to evaluate the artificial images from database 610 against real images from database 602 to discern whether an image from database 610 is real or unreal/fake. Discriminator network 604 is also configured to evaluate the authenticity of data from database 610, by distinguishing between real images (from database 602) and synthetic samples (from database 610). The evaluation performed by discriminator network 604 is provided as feedback to generator network 608 to help improve the images generated by network 608. Images from generator network 608 are considered “improved” when they are realistic or closely resemble real images, such as those from database 602.

The evaluation process implemented by GAN 600 involves generator network 608 trying to fool discriminator network 604, while discriminator network 604 strives to correctly identify real versus artificial data. In embodiments of the present specification the data herein refers to security inspection images. Security inspection images may include all types of scan related data, such as and not limited to transmission X-ray images, scatter X-ray images, neutron transmission and scatter images, shipping documentation, photographs of license plates and photographs of conveyance. Security inspection images may also include three dimensional (3D) volumetric image data of scanned cargo, whereby the artificial image data comprises synthetic 3D voxel-based representations.

The adversarial training process described above continues until generator network 608 produces highly realistic data. Highly realistic data is achieved when the generated images and the real images are subject to testing and the results are compared to obtain the same or similar performance results for corresponding real and generated images. The same or similar results are obtained when the generated images are physically consistent representations of the real images. In other words, highly realistic refers to models that are trained on both generated and real images that yield consistent results. The test and the comparison are both conducted by executing the model in accordance with the present specification on the generated and on the real images. The production of highly realistic data is an indication that the model is ready for training. In embodiments, another attribute may be used if it provides a clearer determination of training readiness for the model.

### GAN Model Training Process

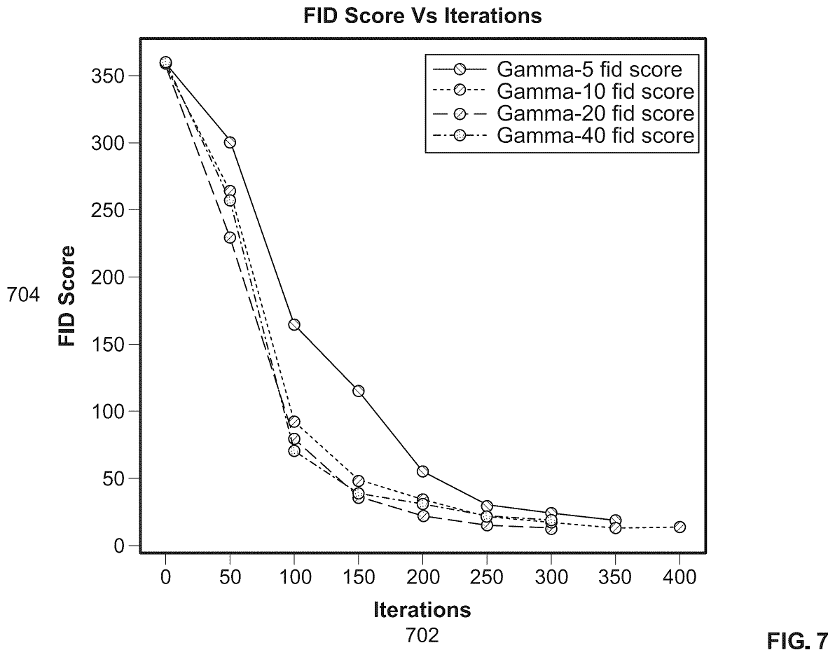

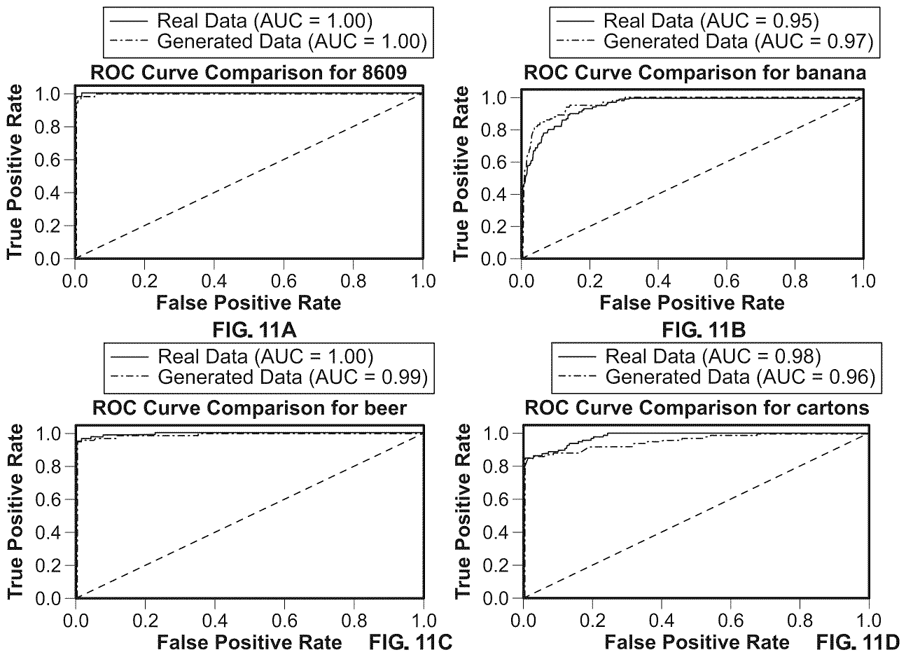

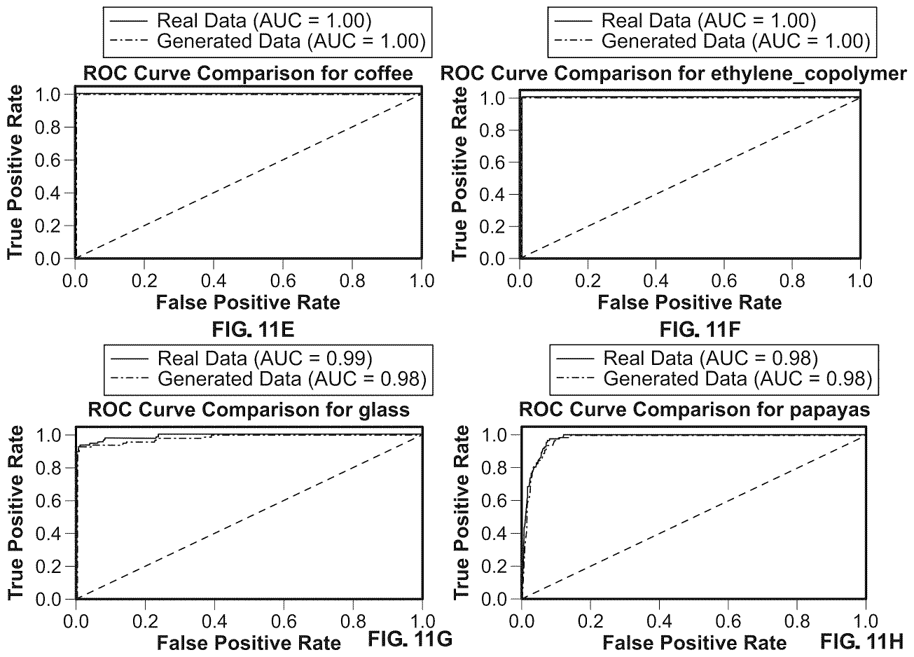

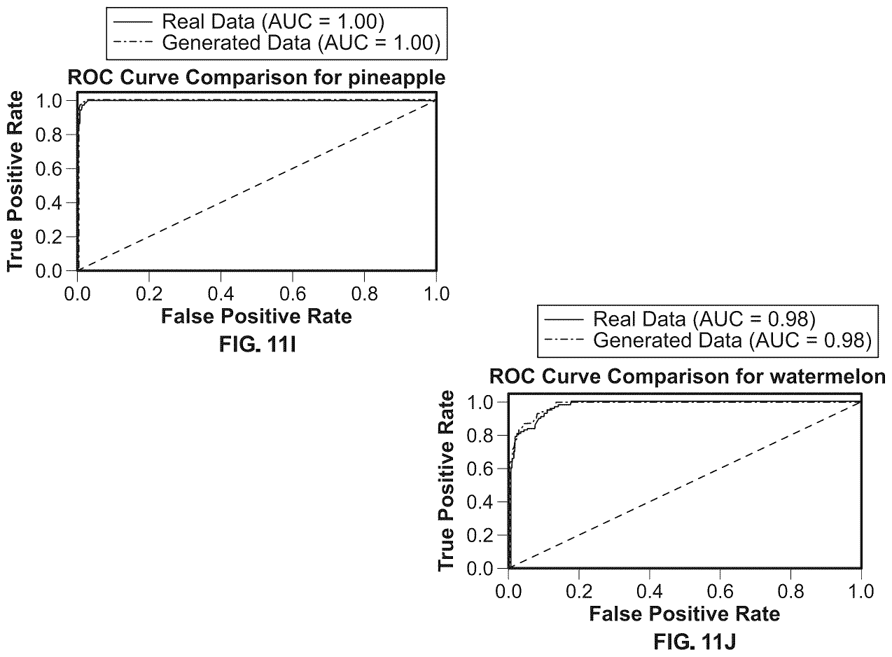

In an exemplary prototype GAN, StyleGAN3 model was used to generate images for demonstration purposes. The training of discriminator neural network was achieved by optimizing Fréchet Inception Distance (FID), which is a metric used to evaluate the quality of generated images by comparing the distribution of features between real and generated images using InceptionV3 classifier. FIG. 7 is a graph showing the quality of an artificially generated image by virtue of the resemblance or similarity of the generated image to the real image, using FID scores, in an embodiment of the present specification. In embodiments, a characteristic or parameter that may be used to determine the similarity is when the realistic artificial image data generated is a physically consistent representation of real image data obtained by the one or more inspection systems. The determination of the similarity may be incomplete if performed using just a few numbers, such as those related to the dimension or related to attenuation, because different images can share the same size and the average attenuation. Therefore, the similarity is measured by analyzing images with a deep neural net classifier (InceptionV3, in one embodiment) to obtain a feature vector. The feature vector is a set of numbers that contain the main characteristics of the image. The FID score compares the mean and the covariance of feature vectors from generated and real images. The generated images are considered to be substantially similar to the real images, or are considered physically consistent representations of the real images, in at least one of two ways. First, a small FID score may be indicative that the generated images are considered to be substantially similar or physically consistent representations of the real images if the FID score is small. The FID score is lower when the distribution of feature vectors of generated images overlaps with the distribution of feature vectors from real images. FIG. 7 shows that the experiment achieves a FID score of approximately 5 after training (which was a score of 350 before training) using the embodiments of the present specification. Secondly, another method that may be used to consider whether the generated images are substantially similar or physically consistent representations of the real images is to compare cargo type classification in real data when the classifier model is trained on generated and real data, as shown and discussed with respect to FIG. 11. When receiver-operator-characteristic (ROC) curves for both training datasets overlap, the models trained on real and generated data have the same performance. As an example, FIG. 11A shows that empty containers are identified by both models with a 2% false positive rate and a 98% true positive rate.

An X-axis 702 illustrates the number of iterations performed to train the generator neural network to create generated images, while a Y-axis 704 shows the FID score. Lower FID scores are indicative of a better quality of generated images. Each line in the graph is representative of a curve corresponding to a different configuration parameter for training. The illustrated configuration parameters are Gamma-5, Gamma-10, Gamma-20, and Gamma-40. Each curve corresponding to a configuration parameter is an indication of the smooth mapping between latent space (intermediate images) and the image space (final image). The configuration parameter is selected such that it ensures a degree of response that is generated in the image space in proportion to small changes in the latent space. A suitable configuration parameter stabilizes the training model and improves the quality of a generated image. If the configuration parameter is too small (less than Gamma-5), the model could lead to unstable image generation and hallucination. Conversely, if the configuration parameter is too large (more than Gamma-40), the model may generate images that are too similar. Therefore, the graph also indicates optimum configuration parameters that may be used for training the generator neural network.

In the exemplary prototype version of the GAN system for image generation, each layer in the StyleGAN3 generator contributes to improving the quality of the images, starting from random noise to producing a final 1024×1024 resolution image. Each layer represents a refinement in the pixels starting from the set of random pixels, wherein the refinement process continues through intermediate layers, up to the pixels for the final image. Each layer refers to the intermediate data and transformation parameters applied to that data to progress to the next layer. Examples of highly realistic generated images are shown in FIG. 2. However, generative models are known to also create data that has unphysical, unrealistic features, which is a result known as ‘hallucination’. A significant effort is dedicated to remove hallucinations from the generated datasets, as described below.

### Generative and Curated Data

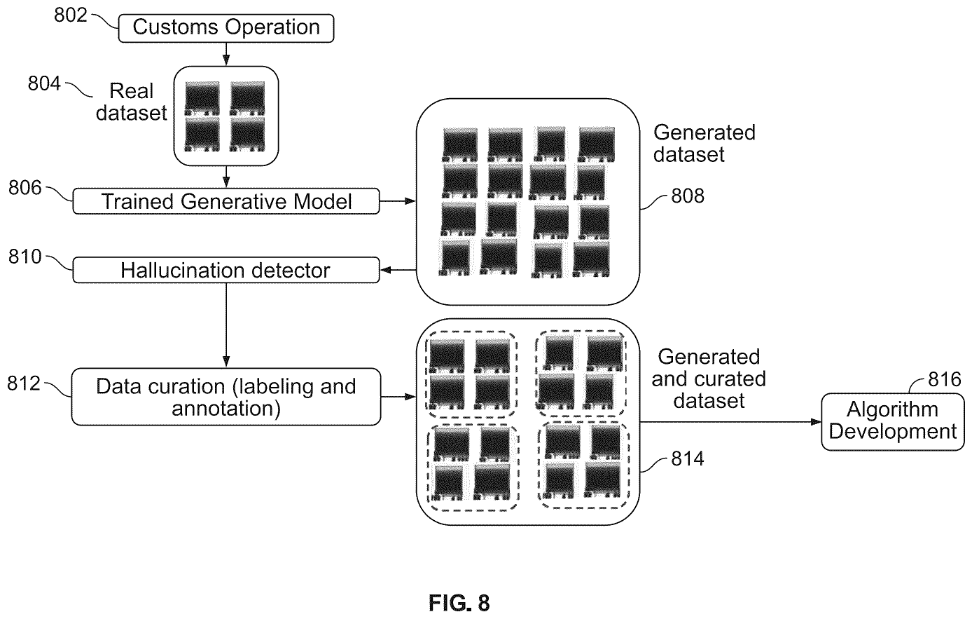

FIG. 8 is a flow diagram illustrating an exemplary process to create generative, curated datasets to generate data to train and/or develop security inspection algorithms for use by inspection systems, in accordance with the various embodiments of the present specification. In embodiments, the process is implemented on one or more inspection systems that are configured to general real image data representative of scanned cargo or conveyance. A processor that is in data communication with one or more inspection systems is configured to receive real image data from one or more inspection systems. The processor is configured to execute programmatic instructions to receive real image data from the one or more inspection systems. In embodiments, a general adversarial network (GAN) is applied to the real image data to generate artificial image data that is a physically consistent representation of the real image data. It should be noted that while a GAN is used as a generator mode in the implementation described herein, other generator modes may be employed, such as, but not limited to diffusion models, variational encoders, and any other technique that achieves the objectives of the present specification. The processor is also configured to detect hallucinated features within the artificial image data using a hallucination detection process comprising a neural network and a support vector machine. The processor is then used to separate the artificial image data into a first group of validated artificial image data and a second group comprising hallucinated artificial image data. User input is then received, via a graphical user interface, to apply curative features comprising labels or annotations to the validated artificial image data to create curated artificial image data. The curated artificial image data is sued to develop a machine learning model for detecting cargo type or contraband.

As described, the system includes a graphical user interface (GUI) operable by a user to review artificial image data; identify hallucinated or artifact-containing images; and apply annotations to image regions corresponding to known objects, containers, or cargo patterns. In embodiments, the graphical user interface allows the user to apply a custom labeling of image regions to designate cargo categories, threat types, or container subtypes.

In embodiments, the one or more inspection systems include an X-ray scanner configured to acquire three dimensional (3D) volumetric image data of scanned cargo, and wherein the artificial image data comprises synthetic 3D voxel-based representations.

In embodiments, the computing system is further configured to apply the generative adversarial network to multi-energy scan data comprising low-energy and high-energy X-ray channels and to generate corresponding artificial dual-energy images

In embodiments, the hallucination detection algorithm process is configured to detect hallucinated features by extracting a feature vector using a convolutional neural network, and classifying the feature vector using the support vector machine trained to distinguish real from unreal image features.

In embodiments, the computing system is further configured to inject one or more scanner artifacts into the artificial image data, and wherein the scanner artifacts comprise at least one of underexposure, scan interruption, scan skew, detector misalignment, and system noise profiles. Further, the artificial image data may include simulated threat objects embedded into cargo scenes which otherwise do not have threats using object insertion algorithms that preserve physical coherence and X-ray attenuation gradients. In embodiments, the machine learning model trained on the curated artificial image data is configured to detect at least one of concealed persons, undeclared electronics, weapons, narcotics, and vehicle parts.

In some embodiments, the system includes a database in which curated artificial image data is stored with metadata linking each image to at least one of a class label, an origin identifier, and a hallucination verification score. In embodiments, a receiver operating characteristic (ROC) analysis is performed by the computing system to evaluate the performance of the trained machine learning model using both real and artificial test datasets. These systems and processes are described in greater detail below.

At step 802, a security inspection operation is performed. The security inspection operation may be a process implemented by a customs authority. In various embodiments, the security inspection operation is performed by at least one inspection module, system, or sub-system. Each inspection module is a radiation-based inspection module configured to non-intrusively inspect objects such as, for example, cargo, trucks, containers, passenger vehicles, and baggage and to non-intrusively scan people. Additional examples of systems that implement embodiments of the present specification include X-ray scanners for cargo containers and vehicles, radiation portal monitors, airport X-ray bag scanners, millimeter wave scanners for people screening, and shipping documentation.

The operation performed at step 802 is used to and is configured to generate a real dataset 804. In some embodiments, dataset 804 includes radiation-based scan image data (such as, for example, X-ray scan image data, microwave, or gamma/neutron-based scanning data) and material characterization data of the object under inspection. In addition, in some embodiments, dataset 804 includes metadata such as, but not limited to, manifest or shipping data (pre-stored in and acquired from a database); optical image data; video data; biometrics data to identify drivers of cargo vehicles (in case of cargo inspection) and to identify people being scanned (in case of people screening); and/or vehicle identification data such as, for example, RFID (Radio Frequency Identification) data, QR code data and license plate data for land cargo and passenger vehicles or container number Optical Character Recognition (OCR) data for sea cargo containers.

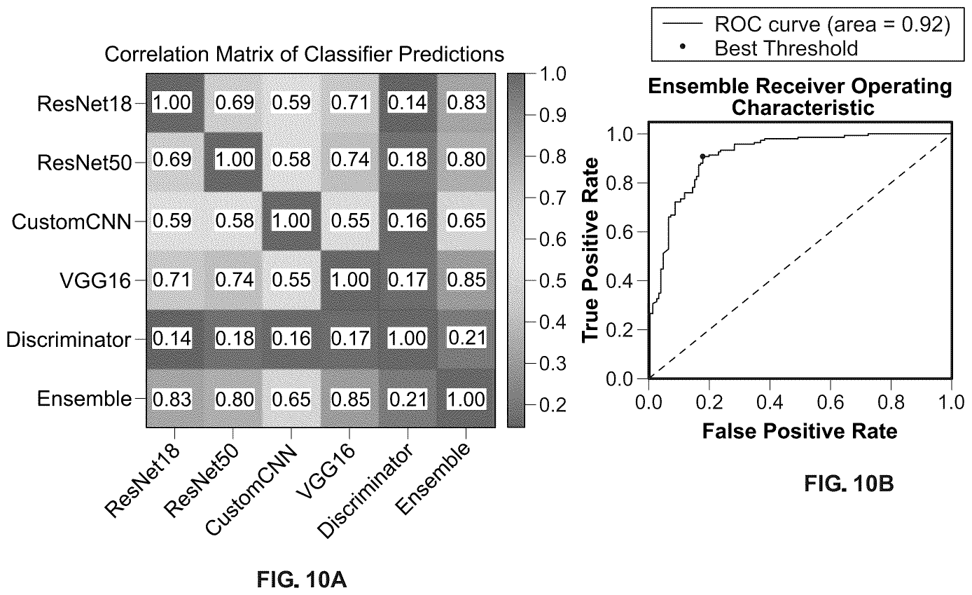

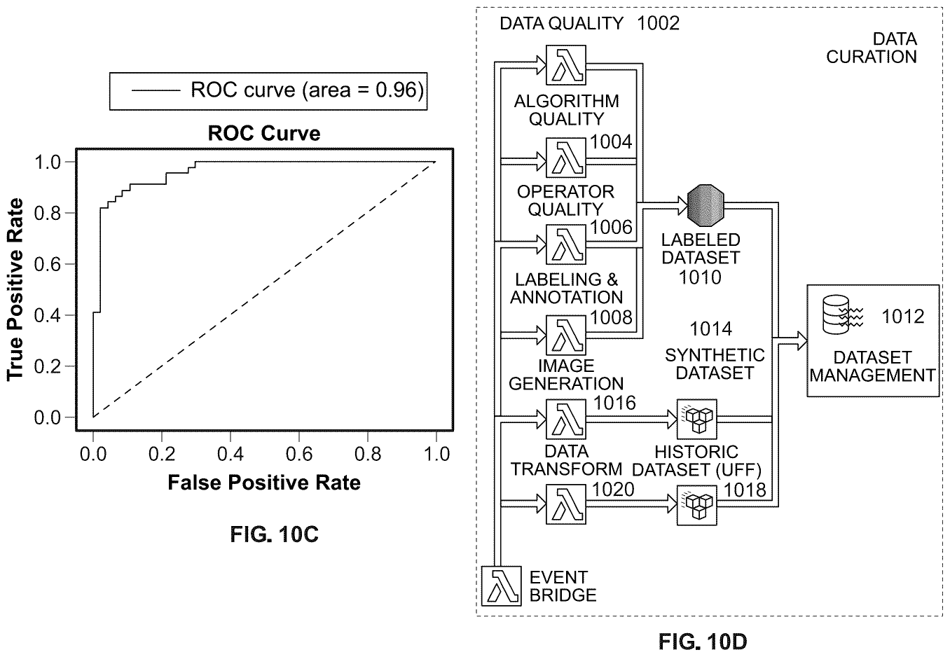

In some embodiments, dataset 804 is communicated, by the inspection module, to the developer module (see FIG. 10) in real-time while concurrently being stored in a database associated with the inspection system. In some embodiments, dataset 804 is stored in a database for further access and retrieval by at least one developer module.

At step 806, dataset 804 is provided as input to a generative model. In some embodiments, the generative model is a GAN model such as that described in FIG. 6 or is a combination of multiple GAN models. The computing systems that are configured to implement the various embodiments of the present specification may be a part of an inspection system, examples of which are provided above, so that the generated data can be used for testing the system data flow. In an exemplary implementation, the x-ray data flow is simulated without actually turning on or activating the x-rays. Additionally, embodiments of the present specification are implemented at a central system that is in communication with one or more inspection systems, and more specifically, at a central or dedicated computing system that is in data communication with the one or more inspection systems. In the centralized system with inspection officers in a command center, the computers that are configured to implement embodiments of the present specification are in a facility that aggregate data from multiple inspection systems. The aggregated data with generated images (threat object) can then be transferred to an operator workstation to test alertness and training of inspection officers. Embodiments of the present specification can also be implemented on an algorithm inference server to test inspection algorithm quality to check whether the algorithms are able to identify objects or problems within generated images. Further, the embodiments of the present specification can be implemented on a completely separate computing system/facility that is configured to dedicatedly develop the model. An example of separate or stand-alone computing device that is configured to implement the various embodiments of the present specification include algorithm training servers that are used to train new training models on generated and curated data. In some embodiments, data preparation for machine learning algorithms is implemented by computing systems that are either in the cloud or on the premise (at a command center or a centralized system). The cloud offers a location for algorithm development with large computing and data storage resources, and may be preferred in some embodiments.

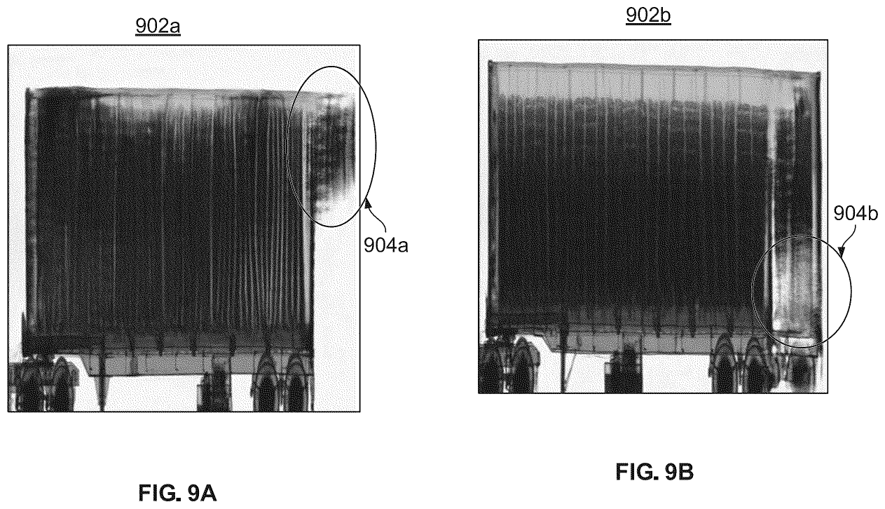

The generative model generates dataset 808 (as it is configured to do so), which is the trained dataset using, for example, the adversarial training process of a GAN. At step 810 the generated dataset 808 is segregated into “good” and “hallucinated” categories. Quality characteristics of the images from generated dataset 808 are used for the segregation. Quality characteristics are features that discriminate between good and hallucinated images. The quality characteristics are defined empirically by looking into generated images and hand labeling features that are unphysical. In some embodiments, the generated dataset images are manually segregated into “good” and “hallucinated” categories based on visual inspection of boundaries, edges, and overall image quality. In this method, the classification of the generated images is performed manually wherein personnel search for parts within generated images that are not present in real scans. The “good” images are those classified as statistically consistent with corresponding images of dataset 804. The “good” generated images are physically realistic and have the correct x-ray pattern of cargo but show variability in cargo packing and conveyance types. FIG. 9A illustrates an example of a hallucinated image where a generated image 902a of container or truck parts 904a is shown hanging in the air. FIG. 9B illustrates another example of a hallucination where a generated image 902b includes a blurred or washed-out region 904b.

Following the classification of the images, one or more classifiers are trained to discriminate against hallucinations. In the above exemplary prototype, several image classifiers were evaluated to detect hallucinations that include a custom CNN, transfer learning from based models (VGG16, ResNet18, ResNet50) and StyleGAN3 own Discriminator. The classifiers may be combined to optimally perform hallucination detection. FIG. 10A shows a correlation between different classifier methods that were evaluated before choosing the final hallucination detector when used in combination, and FIG. 10B shows the performance of various combined hallucination rejection methods that were evaluated before selecting the final method (around 90% True Positive Rate (TPR) at 20% False Positive Rate (FPR)).

In one embodiment, InceptionV3 model is used in combination with Support Vector Machine (SVM) for hallucination detection in image classification. The selection of the classifier for hallucination detection may follow an exemplary method described herein. In an experiment, a study utilized a pretrained InceptionV3 model to extract deep features which were then used to train a SVM classifier to distinguish between good and bad quality generated images of cargo containers. While the InceptionV3 is also used to calculate Fréchet Inception Distance (FID) scores, in this context, the extracted features were directly used for training the SVM classifier. The InceptionV3 model was modified by removing its classification layer to obtain feature vectors. Images were preprocessed using a transformation pipeline that resized them to 299×299 pixels, converted them to grayscale with three channels, and transformed them into tensors. A custom dataset class was created to load images from specified directories with an optional limit on the number of images. Using this setup, four datasets were prepared: good quality training images, bad quality training images, good quality validation images, and bad quality validation images. Data loaders were created for these four datasets with a batch size of 32. The InceptionV3 model was moved to a GPU if available, and features were extracted from the images using this model. The extracted features from the training datasets were combined and labeled (0 for good, 1 for bad) to form the training set, while the features from the validation datasets were combined and labeled to form the validation set. The labelling was performed manually. The criteria for labelling were empirical and based on seeing unphysical features, such as the examples illustrated and described in FIGS. 9A and 9B. An SVM classifier with probability estimation was trained on the training set. The classifier's performance was evaluated on the validation set. The predicted probabilities were used to compute an ROC curve and area under the curve (AUC), with an optimal threshold determined for separating good and bad images based on their FID scores. The FID score is a method used to quantify the similarity between image groups by comparing the mean and the covariance (m,C) of feature vectors from the two groups. The FID calculation may be represented as:

$${d}^{2} ( ( m , C ) , ( {m}_{w} , {C}_{w} ) ) = {‖ m - {m}_{w} ‖}_{2}^{2} + Tr ( C + {C}_{w} - 2 {( {CC}_{w} )}^{1 / 2} )$$

Therefore, in embodiments of the present specification, the feature vectors are computed using InceptionV3 neural net. The FID scores are used to compute the similarity between the image groups, where a lower FID score implies higher similarity.

Following are some exemplary numeric values for the FID score: Comparison of identical groups of images would provide an FID score of 0; In the experiment described above, two groups of real but different images have the FID score of approximately 1 if the groups have the same cargo type (for example while comparing real images of bananas from one image group with real images of bananas from another image group); Comparison of real images of different cargo types (for example, real images of bananas versus real images of pineapples) provide FID scores>50; Generated images before training have FID score of approximately 350 (for example, generated images of bananas versus real images of bananas)—where the FID score after training lowers to approximately 5 (See FIG. 7). The examples provided herein indicate that to obtain a good similarity between generated and real images, the FID score for comparison of real images versus generated images should be small (approximately 5 or less). Further, results of training of classification models on real and generated images should have the same performance. This is shown and described in FIG. 11.

A parameter to determine the similarity is when the generated realistic artificial image data is physically consistent representation of real image data obtained by one or more inspection systems. Determination of the similarity may be incomplete if performed using a few numbers, such as those related to the dimension or related to attenuation, because different images can share the same size and the average attenuation. Therefore, the similarity is measured by analyzing images with a deep neural net classifier (InceptionV3, in one embodiment) to get a feature vector. The feature vector is a set of numbers that contain main characteristic of the image. The FID score compares the mean and the covariance of feature vectors from generated and real images. The generated images are considered to be substantially similar to the real images, or are considered physically consistent representations of the real images, in at least one of the following two ways: First, the FID score is small. The FID score is less when the distribution of feature vectors of generated images overlaps with the distribution of feature vectors from real images. FIG. 7 shows that the experiment achieves the FID score of approximately 5 after training (which is a score of 350 before the training) using the embodiments of the present specification. Another method compares cargo type classification in real data when the classifier model is trained on generated and real data, as shown and discussed in FIG. 11. When receiver-operator-characteristic (ROC) curves for both training datasets overlap, then the models trained on real and generated data have the same performance. As an example, FIG. 11A shows that empty containers are identified by both models with 2% false positive rate and 98% true positive rate.

The combination of InceptionV3 and SVM was a chosen hallucination detection method, which demonstrated high accuracy and the ability to effectively distinguish between good and bad quality images, making it a reliable approach also for application in embodiments of the present specification. FIG. 10C illustrates graph with the ROC curve plotted using final hallucination detector on exemplary pineapple images.

At step 812, the resulting “super” dataset from step 810, which comprises all datasets classified as “good”, is curated. The process of curation comprises annotation and labelling, such as that illustrated in FIG. 5B, and results in the generation of a curated dataset 814. The process of curation is performed by developers using a graphical user interface that is in communication with a processor. In a typical curation process using the GUI, an image is displayed with buttons to select an option from good or bad, and buttons to advance through images. Labelers inspect the displayed images and use the buttons to mark each image as good when no signs of hallucination are identified, and as bad where signs of hallucination are identified.

FIG. 10D illustrates an exemplary set of features for data curation, which may be used within embodiments of the present specification. Referring to the figure, the first feature 1002 is data quality, which is configured to enable performing a quality and integrity check of data received

from NII systems, and in more details described in FIG. 4. The data includes a unique scan identifier associated with each scanned image or type of scan. Variables within the data that are used to verify the quality of scan include the type of scanner and the type of algorithm, in addition to other variables related to the quality described in FIG. 4. After the check is performed, information indicative of the quality or integrity of the data is generated and presented through a GUI. Similarly, other steps include algorithm quality 1004 that checks if the performance of threat detection algorithms is stable over time, operator quality 1006 that relates to the quality of operator decision associated with a scan image, labeling and annotation 1008 which is also described in FIG. 5B, wherein together features from 1002 to 1008 provide labeled dataset 1010.

Features of data curation may be broadly classified in to two types: those that relate to data quality and those that pertain to labelling and annotation. In the first type of features, which relate to data quality, the variables are configured to check if X-ray images are affected by normalization or calibration problems, such as for example if the images are too dark/bright, or if the images are of incorrect material colors. The check is also performed to determine whether the X-ray scan is properly executed, if the image has issues arising due to problems with the X-ray source, if there is an interference with other systems, or if there are data conversion problems. In the second type of features, which relate to labelling and annotation, the cargo type, the container type, the vehicle type are identifies in addition to annotating of image segments (container segment, refrigeration unit, tuck cabin, among other types of segments).

FIG. 10D additionally illustrates a dataset management database 1012, which combines synthetic dataset 1014 from generated images at 1016 (step 808 of FIG. 8) and historic dataset 1018 which includes real scan images after transformation at 1020. Data transformation at 1020 may comprise converting the real data to non-proprietary data and removal of digital signature.

### Final Validation and Evaluation

In an experiment, images were generated using the above methods of the present specification, for 10 different cargo types including: Banana, Pineapple, Watermelon, Papaya, Carton, Glass, Beer, Empty Containers or 8609 Containers, Ethylene Copolymer, and Coffee. These images were segregated into “good” and “hallucinated” or “bad” categories using the hallucination detector built with the InceptionV3 and SVM model described in the previous section.

The quality of the generated images and their correspondence to the original cargo types were evaluated. For the purpose of the evaluation, a multi-class image classifier was trained. This study utilized a pretrained VGG16 model to classify the above-mentioned 10 different cargo types. The dataset was divided into training and validation sets, with images preprocessed to 224×224 pixels, converted to grayscale with three channels, and normalized. Data augmentation techniques such as random horizontal flip and rotation were applied to the training set. A custom dataset class was created to load images and labels, excluding any unwanted files. Data loaders were prepared with a batch size of 8.

The VGG16 model was modified by freezing all layers except the last four in the feature extractor and replacing the final classifier layer to match the number of classes. The model was trained using the SGD optimizer with a learning rate of 0.0001 and weight decay of 0.01. A step learning rate scheduler was employed to reduce the learning rate by a factor of 0.1 every 10 epochs. Training ran for 50 epochs with early stopping implemented to prevent overfitting. The model was first trained on real images and validated on real images. Subsequently, it was trained on generated images and validated on real images. The performance of the model was evaluated using ROC curves and AUC scores for each class. FIGS. 11A to 11J illustrate ROC Curve Comparison for each cargo type. FIG. 11A illustrates the ROC curve comparison for 8609 containers. FIG. 11B illustrates the ROC curve comparison for banana containers. FIG. 11C illustrates the ROC curve comparison for beer containers. FIG. 11D illustrates ROC curve comparison for carton containers. FIG. 11E illustrates ROC curve comparison for coffee containers. FIG. 11F illustrates ROC curve comparison for ethylene copolymer containers. FIG. 11G illustrates ROC curve comparison for glass containers. FIG. 11H illustrates ROC curve comparison for papaya containers. FIG. 11I illustrates ROC curve comparison for pineapple containers. FIG. 11J illustrates ROC curve comparison for watermelon containers.

The ROC curves for both training methods (using real data and using generated data) were compared for each cargo type, and it was found that the ROC curves were similar, largely overlapping, therefore indicating comparable performance between training on real images and training on generated images.

Referring again to FIG. 8, at step 816, the generated and curated dataset is used for development of algorithms or for training of one or more ML algorithms used in inspection systems. In one embodiment, the inspection system is in data communication with the training module to use real-time generated and curated dataset in the training of the ML algorithms.

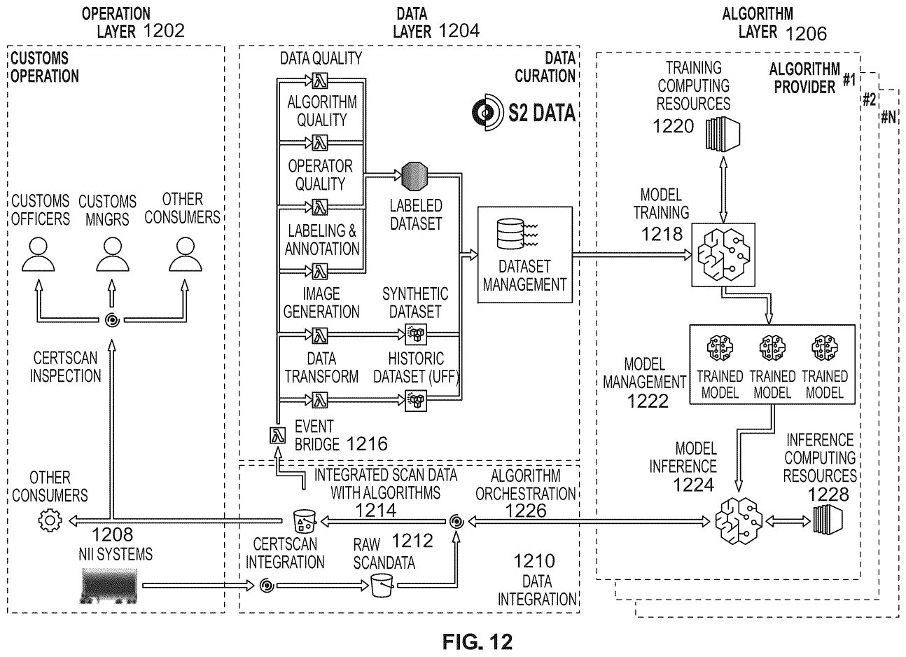

FIG. 12 is an overview of a network within which data generation and curation is performed to train one or more processes implemented by ML algorithms. Referring to FIG. 12, a first layer 1202 comprises an NII operation that sends data to a second layer 1204 involving curation operation (also described in FIG. 10D) that further prepares data for use by a third layer 1206 which comprises algorithm development by use of AI. First layer 1202 is at the level of the customs operation or at the security inspection level. One or more NII system 1208 send actual scan data to an additional data integration layer 1210. At layer 1210, raw scan data 1212 from NII systems 1208 is integrated with ML algorithms at 1214, where the ML algorithms are fed back from third layer 1206. An event bridge 1216 feeds the scan data to the curation operation of layer 1204. The curation operation is described with reference to FIG. 10D. Curated data from layer 1204 is provided as input for model training 1218 using ML algorithms. Training computing resources 1220 are in communication with model training 1218 operation. Trained models output by model training 1218 are saved within a model management database 1222. Model inference 1224 is derived from model management database 1220, which is looped back for algorithm orchestration 1226 for integration with actual scan data at 1214. Model inference is developed using inference computing resources 1228. Layer 1206 can be shared with multiple algorithm providers with training computing resources 1220 and inference computing resources 1228, which parallelly provide algorithms for integration with scan data.

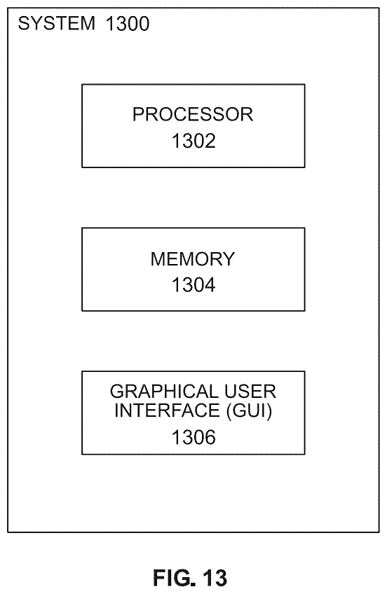

FIG. 13 is a block diagram showing an exemplary system architecture 1300, according to embodiments of the present specification. System 1300 may include a processor 1302, a memory 1304, and a Graphical User Interface (GUI) 1306.

In one embodiment, the system 1300 may be a developer system. One of ordinary skill in the art would appreciate that the features described in the present application can operate on any computing platform including, but not limited to: a laptop or tablet computer; personal computer; personal data assistant; cell phone; server; embedded processor; DSP chip or specialized imaging device capable of executing programmatic instructions or code.

It should further be appreciated that the platform provides the functions described in the present application by executing a plurality of programmatic instructions, which are stored in one or more non-volatile memories, using one or more processors and presents and/or receives data through transceivers in data communication with one or more wired or wireless networks.

It should further be appreciated that each computing platform has wireless and wired receivers and transmitters capable of sending and transmitting data, at least one processor capable of processing programmatic instructions, memory capable of storing programmatic instructions and image, and software comprised of a plurality of programmatic instructions for performing the processes described herein. Additionally, the programmatic code can be compiled (either pre-compiled or compiled “just-in-time”) into a single application executing on a single computer, or distributed among several different computers operating locally or remotely to each other.

Processor 1302 includes suitable logic, circuitry, and/or interfaces that are operable to execute instructions stored in the memory to perform various functions. Processor 1302 may execute an algorithm stored in memory 1304 for performing operations such as sourcing the real dataset from an inspection system, implementing a generative training model on the dataset, detecting hallucinated dataset, curating filtered dataset, and sending the curated dataset to train one or more algorithms or processes. Processor 1302 may also be configured to decode and execute any instructions received from one or more other electronic devices or server(s). Processor 1302 may include one or more general-purpose processors (e.g., INTEL® or Advanced Micro Devices® (AMD) microprocessors), a Graphics Processing Unit (e.g. NVIDIA RTX 390), and/or one or more special-purpose processors (e.g., digital signal processors or Xilinx® System-On-Chip (SOC) Field Programmable Gate Array (FPGA) processor). Processor 1302 may be further configured to execute one or more computer-readable program instructions, such as program instructions to carry out any of the functions described in the description.

Further, processor 1302 may be configured to make decisions or determinations, generate frames, packets or messages for transmission, decode received frames or messages for further processing, and other tasks or functions described herein. Processor 1302, which may be a baseband processor, for example, may be configured such that it can generate messages, packets, frames or other signals for transmission via wireless transceivers. It should be noted that processor 1302 may be configured such that it is able to control the transmission of signals or messages over a wireless network, and may control the reception of signals or messages, or any other communication via a wireless network (for example, after being down-converted by a wireless transceiver). Processor 1302 may be (or may include), for example, hardware, programmable logic, a programmable processor that executes software or firmware, and/or any combination of these. Further, using other terminology, processor 1302 along with the transceiver may be considered as a wireless transmitter/receiver system, for example.

Memory 1304 is configured to store a set of instructions and data. Further, memory 1304 includes one or more instructions that are executable by processor 1302 to perform specific operations. Some of the commonly known memory implementations include, but are not limited to, fixed (hard) drives, magnetic tape, floppy diskettes, optical disks, Compact Disc Read-Only Memories (CD-ROMs), and magneto-optical disks, semiconductor memories, such as ROMs, Random Access Memories (RAMs), Programmable Read-Only Memories (PROMs), Erasable PROMs (EPROMs), Electrically Erasable PROMs (EEPROMs), flash memory, magnetic or optical cards, cloud computing platforms (e.g. Microsoft Azure and Amazon Web Services, AWS), or other types of media/machine-readable medium suitable for storing electronic instructions.

In embodiments, the present disclosure may be provided as a computer program product, which may include a computer-readable medium tangibly embodying thereon instructions, which may be used to program a computer (or other electronic devices) to perform a process. The computer-readable medium may include, but is not limited to, fixed (hard) drives, magnetic tape, floppy diskettes, optical disks, Compact Disc Read-Only Memories (CD-ROMs), and magneto-optical disks, semiconductor memories, such as ROMs, Random Access Memories (RAMs), Programmable Read-Only Memories (PROMs), Erasable PROMs (EPROMs), Electrically Erasable PROMs (EEPROMs), flash memory, magnetic or optical cards, or other types of media/machine-readable medium suitable for storing electronic instructions (e.g., computer programming code, such as software or firmware). Moreover, embodiments of the present specification may also be downloaded as one or more computer program products, wherein the program may be transferred from a remote computer to a requesting computer by way of data signals embodied in a carrier wave or other propagation medium via a communication link (e.g., a modem or network connection).

GUI 1306 may be used by an operator or developer to segregate and curate data. The curated data generated by the operator is communicated to processor 1302 or a different processing system to train or develop an algorithm for use by an inspection system. GUI 1306 may either accept inputs from operators or facilitate outputs to the operators, or may perform both the actions. In one case, an operator may interact with the interface(s) using one or more user-interactive objects and devices. The interactive objects and devices may comprise user input buttons, switches, knobs, levers, keys, trackballs, touchpads, cameras, microphones, motion sensors, heat sensors, inertial sensors, touch sensors, or a combination of the above. Further, the interface(s) may either be implemented as a Command Line Interface (CLI), a Graphical User Interface (GUI), a voice interface, or a web-based user-interface. In one embodiment, GUI 1306 may send notifications in a user-friendly or interactive form to the operator.

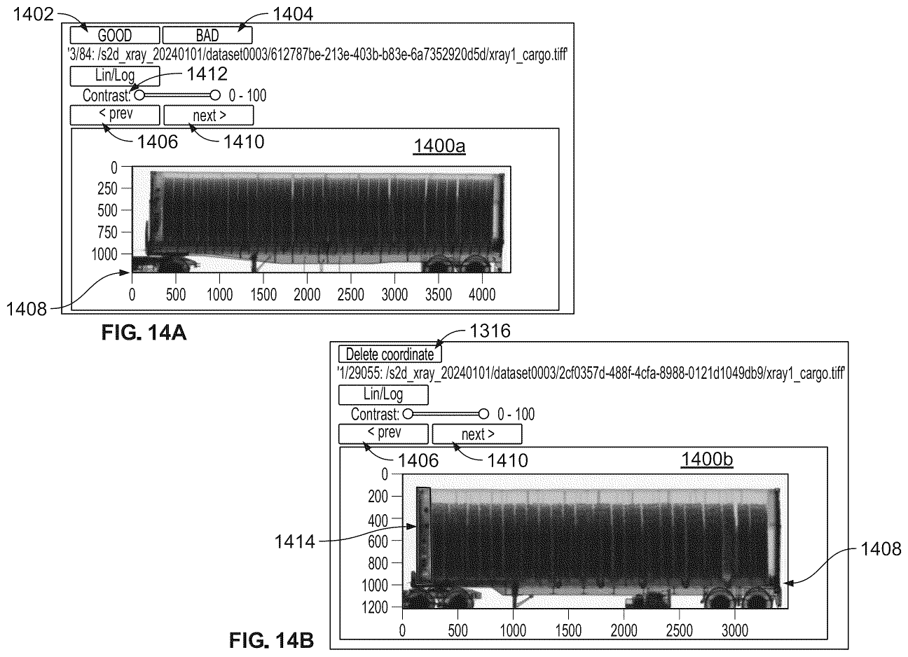

FIG. 14A is an exemplary GUI 1400a, in accordance with some embodiments of the present specification. GUI 1400a is displayed to an operator with options to advance through images and to label quality of a displayed image. A first button 1402 provides the option to select “Good” as one type of quality and a second button 1404 provides the option to label the image quality as “Bad”. A third button 1406 provides an option to view an image prior to displayed image 1408, while a fourth button 1410 provides an option to view a next image after displayed image 1408. A sliding button 1412 provides an option to adjust contrast within the displayed image 1408. FIG. 14B illustrates another example GUI 1400b, in accordance with some embodiments of the present specification. GUI 1400b illustrates an annotated region 1414 within displayed image 1408, where the annotation is created by the operator using an annotating tool. In one exemplary embodiment, the operator may click and drag a pointer controlled with an external device (such as a mouse), to mark a region within displayed image 1408. A button 1416 may be displayed within GUI 1400b to provide an option to delete the latest annotation.

It will be apparent to one skilled in the art that the above-mentioned components of system 1300 and GUI 1400a and 1400b have been provided only for illustration purposes. In one embodiment, system 1300 may include an input device, and an output device, as well, without departing from the scope of the disclosure. Features that are described and/or illustrated with respect to one embodiment may be used in the same way or in a similar way in one or more other embodiments and/or in combination with or instead of the features of the other embodiments.

While the above embodiments have been illustrated and described, as noted above, many changes can be made without departing from the scope of the embodiments. For example, aspects of the subject matter disclosed herein may be adopted on alternative operating systems. Accordingly, the scope of the embodiments is not limited by the disclosure of the embodiment. Instead, the embodiments should be determined entirely by reference to the claims that follow.

What is claimed is:

1. A computer readable non-transitory medium comprising a plurality of executable programmatic instructions that, when executed in a computer system, enables a plurality of different machine learning frameworks to be applied to image data, wherein the image data is acquired from one or more inspection systems and wherein the plurality of executable programmatic instructions, when executed:
receives the image data from the one or more inspection systems;
using the received image data and at least one machine learning framework, generates artificial image data that is physically consistent representation of the received image data;
detects a characteristic of the generated artificial image data;
receives an instruction to apply one or more curative features to the generated artificial image data based on the detected characteristic to create generated and curated image data;
develops one or more processes using the generated and curated image data for implementation by at least one of an operator workstation and the one or more inspection systems; and
causes at least one of the operator workstation and the one or more inspection system to implement the one or more developed processes.

2. The computer readable non-transitory medium of claim 1, wherein the received image data is at least partially representative of cargo.

3. The computer readable non-transitory medium of claim 1, wherein the received image data is acquired by the operator workstation in data communication with at least one of the one or more inspection systems.

4. The computer readable non-transitory medium of claim 1, further comprising programmatic instructions that, when executed, train the at least one machine learning framework based on the received image data.

5. The computer readable non-transitory medium of claim 1, wherein the at least one machine learning framework comprises at least one generative adversarial network (GAN).

6. The computer readable non-transitory medium of claim 5, wherein the GAN comprises at least one generator neural network and at least one discriminator neural network.

7. The computer readable non-transitory medium of claim 1, wherein the received image data is representative of at least one of a two-dimensional X-ray image, a three-dimensional X-ray image, a tomographic X-ray image, a multi-energy X-ray image, a backscatter X-ray image, and a transmission X-ray image.

8. The computer readable non-transitory medium of claim 1, wherein the curative features comprise at least one of labels and annotations to the generated image data.

9. The computer readable non-transitory medium of claim 1, wherein the detection of the characteristic comprises determining whether the generated image data comprises hallucinations indicative of one or more unrealistic features and further comprises a plurality of executable programmatic instructions that, when executed, separates the hallucinations from the generated image data.

10. A method of enabling a plurality of different machine learning frameworks to be applied to image data, wherein the image data is acquired from one or more inspection systems and, said method comprising:
receiving image data from the one or more inspection systems;
using received image data and at least one machine learning framework, generating artificial image data that is substantially similar to the received image data;
detecting a quality characteristic of the generated artificial image data;
receiving an instruction to apply one or more curative features to the generated artificial image data based on the detected quality characteristic to create generated and curated image data; and
developing one or more processes using the generated and curated image data for implementation by at least one of an operator workstation and the one or more inspection systems; and
causing at least one of the operator workstation and the one or more inspection system to implement the one or more developed processes.

11. The method of claim 10, wherein the received image data is at least partially representative of cargo.

12. The method of claim 10, wherein the received image data is acquired by the operator workstation in data communication with at least one of the one or more inspection systems.

13. The method of claim 10, further comprising training the at least one machine learning framework based on the received image data.

14. The method of claim 10, wherein the at least one machine learning framework comprises at least one generative adversarial network (GAN).

15. The method of claim 14, wherein the GAN comprises at least one generator neural network and at least one discriminator neural network.

16. The method of claim 10, wherein the received image data is representative of at least one of a two-dimensional X-ray image, a three-dimensional X-ray image, a tomographic X-ray image, a multi-energy X-ray image, a backscatter X-ray image, and a transmission X-ray image.

17. The method of claim 10, wherein the applying the curative features comprises at least one of applying labels and annotations to the generated image data.

18. The method of claim 10, wherein further comprising determining whether the generated image data comprises hallucinations indicative of one or more unrealistic features and separating the hallucinations from the generated image data.

19. A system comprising:
one or more inspection systems that produce image data;
at least one computing system in data communication with the one or more inspection systems and configured to implement one or more machine learning frameworks that receive the image data from the one or more inspection systems and generate artificial image data that is substantially similar to the received image data, wherein the at least one computing system comprises a user interface configured to:
enable detecting quality characteristics of the generated artificial image data; and
receive an instruction to apply curative features to the generated artificial image data to create generated and curated image data for developing one or more algorithms for implementation by the one or more inspection systems.

20. The system of claim 19, wherein at least one of the one or more machine learning frameworks comprises a GAN.

21. The system of claim 19, wherein the received image data is representative of at least one of a two-dimensional X-ray image, a three-dimensional X-ray image, a tomographic X-ray image, a multi-energy X-ray image, a backscatter X-ray image, and a transmission X-ray image.
